(19) United States
(12) Patent Application Publication
(10) Pub. No.: US 2011/0145283 A1
(43) Pub. Date: Jun. 16, 2011

(54) INTELLIGENT MECHANISM FOR IDENTIFYING ONTOLOGICAL HYPERTEXT AND PRE-FETCHING AND PRESENTING THE TARGET INFORMATION

(75) Inventors: YAN W. STEIN, SAN JOSE, CA (US); SANDEEP R. PATIL, SOMERS, NY (US); HARSHWARDHAN S. MULAY, SOLAPUR (IN); ABHINAY R. NAGPAL, MAHARASHTRA (IN)

(73) Assignee: INTERNATIONAL BUSINESS MACHINES CORPORATION, ARMONK, NY (US)

(21) Appl. No.: 12/635,395

(22) Filed: Dec. 10, 2009

(51) Int. Cl. G06F 17/30; G06F 17/21

(52) U.S. Cl. 707/770; 715/205; 707/E17.014; 707/E17.032

(57) ABSTRACT

A computer implemented method for identifying ontological hypertext and pre-fetching and presenting the target information may include receiving an original query by a database server. The method may also include searching the database server to locate an ontological mapping record. The ontological mapping record may represent an association between information responsive to the original query and related information associated by ontological hypertext. The method may further include presenting information responsive to the original query and the related information.

### BACKGROUND

Aspects of the present invention relate to databases and retrieving information from databases, and more particularly to an intelligent mechanism for identifying ontological hypertext and pre-fetching and presenting the target information.

Web documents, such as Extensible Mark-up Language (XML) documents can be grouped and stored on a server. These documents may also be annotated and linked to related data or a dynamic set of knowledge entities. However, the information in these entities may not be contained on the same data server as the web documents or XML documents and the Uniform Resource Locator (URI) to these knowledge entities may not be validated. Even if the related data or information resides on the same server, a lack of association information linking the knowledge entities makes it difficult to explore or access these related knowledge entities. Accordingly, a query for information contained in a particular document on the server cannot be leveraged for also obtaining enhanced information related to the original query.

### BRIEF SUMMARY

In accordance with an aspect of the present invention, a computer implemented method for identifying ontological hypertext and pre-fetching and presenting the target information may include receiving an original query by a database server. The method may also include searching the database server to locate an ontological mapping record. The ontological mapping record may represent an association between information responsive to the original query and related information associated by ontological hypertext. The method may further include presenting information responsive to the original query and the related information.

In accordance with an aspect of the present invention, a system for identifying ontological hypertext and pre-fetching and presenting the target information may include a database server. A module on the database server may be adapted to search the database server to identify ontological hypertext. The ontological hypertext associates information responsive to an original query received by the database server to ontological information. The ontological information may be information related to the information responsive to the original query. A module on the database server may send the information responsive to the original query and the ontological information to a requester that sent the original query.

In accordance with a further aspect of the present invention, a computer program product for identifying ontological hypertext and pre-fetching and presenting the target information may include a computer readable storage medium having computer readable program code embodied therewith. The computer readable program code may include computer readable program code configured to receive an original query by a database server. The computer readable program code may also include computer readable program code configured to search the database server to locate an ontological mapping record. The ontological mapping record represents an association between information responsive to the original query and related information associated by ontological hypertext. The computer readable program code may additionally include computer readable program code configured to present information responsive to the original query and the related information.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a flow chart of an example of a method for identifying ontological hypertext and pre-fetching and presenting the target information in accordance with an embodiment of the present invention.

FIG. 2A is an example of an original XML document which may be accessed in response to an original query in accordance with an embodiment of the present invention.

FIG. 2B is an example of ontological hypertext 202 linking to related, collaborative or ontological data in accordance with an embodiment of the present invention.

FIG. 2C illustrates an example of a mapping record in accordance with an embodiment of the present invention.

FIG. 3 is an illustration of an example of using ontological hypertext to link to related, collaborative or ontological information in accordance with an embodiment of the present invention.

FIG. 4 is an illustration of an example of presenting information related to the original query and corresponding ontological or collaborative information in accordance with an embodiment of the present invention.

FIG. 5 is a block schematic diagram of an example of a system for identifying ontological hypertext and pre-fetching and presenting the target information in accordance with another embodiment of the present invention.

### DETAILED DESCRIPTION

The following detailed description of embodiments refers to the accompanying drawings, which illustrate specific embodiments of the invention. Other embodiments having different structures and operations do not depart from the scope of the present invention.

As will be appreciated by one of skill in the art, aspects of the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer-readable medium(s) may be utilized. The computer-readable medium may be a computer readable signal medium or a computer readable storage medium. A computer-readable storage medium may be, for example, but not limited to, an electronic, magnetic, optical, electromagnetic, infrared, or semiconductor system, apparatus, a device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Note that the computer-readable storage medium could even be paper or another suitable medium upon which a program is printed, as the program can be electronically captured, via, for instance, optical scanning of the paper or other medium, then compiled, interpreted, or otherwise processed in a suitable manner, if necessary, and then stored in a computer memory. In the context of this document, a computer-readable storage medium may be any medium that can contain, or store a program for use by or in connection with an instruction execution system, apparatus, or device.

A computer readable signal medium may include a propagated data signal with computer readable program code embodied therein, for example, in base band or as part of a carrier wave. Such a propagated signal may take any of a variety of forms, including, but not limited to, electro-magnetic, optical, or any suitable combination thereof, A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc. or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other device to cause a series of operational steps to be performed on the computer, other programmable apparatus, or device to produce a computer implemented process such that the instructions which execute on the computer or other programmable apparatus provide processes for implementing the functions/acts specified in the flowchart and/or block diagram block or blocks.

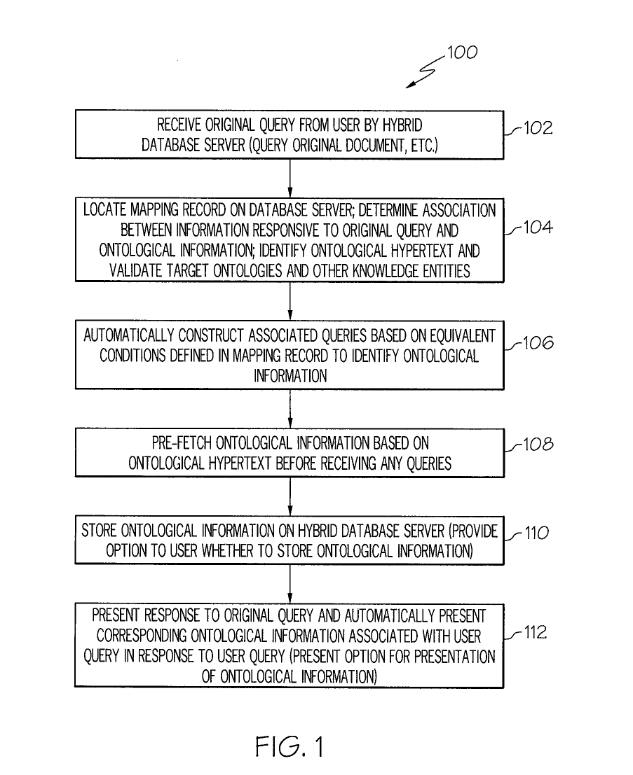

FIG. 1 is a flow chart of an example of a method 100 for identifying ontological hypertext and pre-fetching and presenting the target information in accordance with an embodiment of the present invention. In block 102, an original query from a user may be received by a database server. The database server may be a hybrid database server or the like which can combine a relational database with XML native support or the like, such as SQL/XML (Structured Query Language/Extensible Mark-up Language), XQuery support to query documents or similar functionality depending upon the nature of the database server and the information or documents stored.

In block 104, the database server may be searched to locate an ontological mapping record. An ontological mapping record may be defined as a record representing an association between information responsive to an original query and ontological information or related or collaborative information to the information or data response to the query. The ontological, related or collaborative information may be linked to or associated with the information responsive to the original query by ontological hypertext. Ontological information as used herein focuses on the association of information between two or more tables or information in different columns of the same table. As described in more detail herein, the tables may be pre-fetched and stored on a single database server. Such ontological information can be saved in relational tables, as an XML data type in a hybrid database server or in an XML-format data (physical) file. A module on the database server may identify ontological hypertext and validate target ontologies and knowledge entities on the database server.

In block 106, an associated query or associated queries based on a user defined equivalent condition or an equivalent condition or conditions defined in the mapping record may be automatically constructed to identify ontological information. As described in more detail below, navigation mapping may be used to keep the user defined equivalent condition.

In block 108, related, collaborative or ontological data or information may be pre-fetched or retrieved. The related, collaborative or ontological data or information may be pre-fetched before any queries from a user. In block 110, the ontological or related information may be stored on the database server or hybrid database server. The system may provide an option to the user to decide or select whether to store the ontological information or not on the same server.

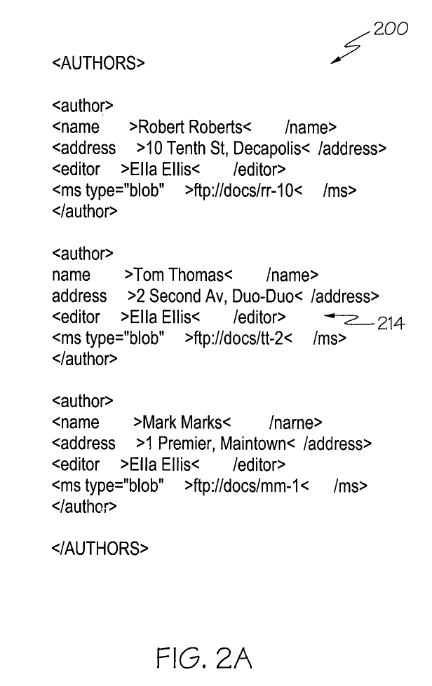

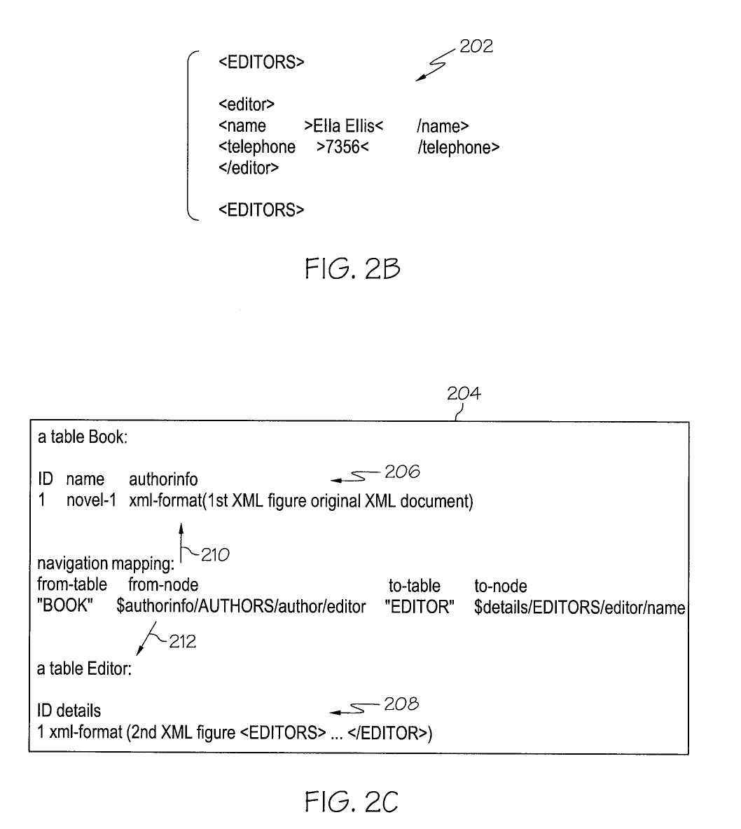

As previously described, navigation mapping may be used to keep the user defined equivalent condition. The navigation mapping may be saved in the XML format (e.g. navmapping.xml) and checked at the query construction stage. Referring also to FIGS. 2A, 2B and 2C, FIG. 2A is an example of an original XML document 200 which may be accessed in response to an original query in accordance with an embodiment of the present invention. FIG. 2B is an example of ontological hypertext 202 linking to related, collaborative or ontological data or information in accordance with an embodiment of the present invention. FIG. 2C illustrates an example of a mapping record 204 showing a relationship between a table Book 206 and a table Editor 208 as illustrated by arrows 210 and 212 in accordance with an embodiment of the present invention. The mapping record illustrated in FIG. 2C may be stored on the database server in a navmapping.xml format as:

<mapping-#n>
<from>
<tablename>BOOK</tablename>
<node>$authorinfo/AUTHORS/author/editor</node>
</from>
<to>
<tablename>EDITOR</tablename>
<node>$details/ED1TORS/editor/name</node>
</to>
</mapping-#n>

When a user tries to find the editor with name “Ella Ellis” 214 in the original XML document 200, for example, in the table BOOK 206, the query is constructed to user “$authorinfo/AUTHORS/author/editor=‘Ella Ellis’” as a condition to search table BOOK 206. Under this disclosed system, the user can expect the expanded results in the database, which means the system searches the navmapping.xml to locate the mapping record 204 and automatically construct another query using equivalent search condition, “$details/EDITORS/editor/name=‘Ella Ellis’”, to retrieve the table EDITOR 208.

This mechanism may not only apply to XML-XML mapping, but may also be expanded to XML-relationalColumn and relationalColumn-relationalColumn easily. For example, given a table HISTORY(id int not null, name varchar(50), location varchar(30)), which has record: (199, ‘Ella Ellis’, ‘New York’), defines the association in navmapping.xml:

<mapping-#m>
<from>
<tablename>BOOK</tablename>
<node>$authorinfo/AUTHORS/author/editor</node>
</from>
<to>
<tablename> HISTORY </tablename>
<node>$name</node>
</to>
</mapping-#n>

When the query with search predicate “$authorinfo/AUTHORS/author/editor=‘Ella Ellis’” is constructed, the extended search can build a query with predicate “name=‘Ella Ellis’”. With such an associative computing mechanism, the application can explore the collaborative data information or ontological information widely from the database server or hybrid database server. This is a major benefit to implementing the ontological association mechanism as described herein in a hybrid database server or similar server.

Navigation mapping information may also be stored as table records. For example, a mapping table can be defined in the database server:

| create table mapping ( id int, | |
|---|---|
| from_table | varchar(80), |
| from_node | varchar(2000), |
| to_table | varchar(80), |
| to_node | varchar(2000) |
| ) | |

As for the preceding XML mapping format records, the following data records can be stored in this defined table MAPPING:

```
(1, ‘BOOK’, ‘$authorinfo/AUTHORS/author/editor’,
  ‘EDITOR’, ‘$details/EDITORS/editor/name’)
(2, ‘BOOK’, ‘$authorinfo/AUTHORS/author/editor’,
  ‘HISTORY’, ‘$name’)
```

The query construction can retrieve the mapping information from the table and build the related query to get expanded results based on the equivalent predicate.

Referring back to FIG. 1, in block 112 information or data responsive to the original query may be presented along with corresponding related, collaborative or ontological data or information may also be automatically presented in response to the user query.

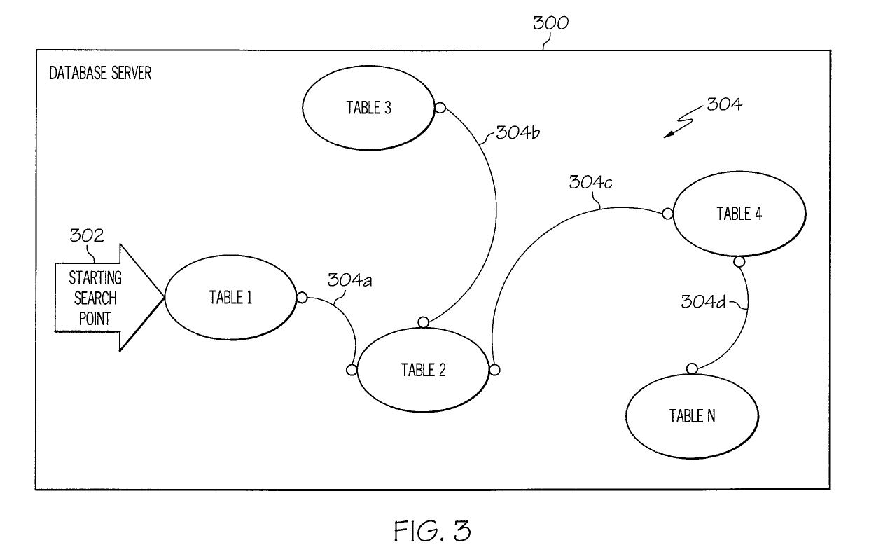

Referring also to FIG. 3, FIG. 3 is an illustration of an example using ontological hypertext to link to or associate with related or collaborative information in accordance with an embodiment of the present invention. An original query received by the database server 300 may start a search point 302 at table 1. Table 1 may contain information responsive to the original query received by the database server 300 from a user. As illustrated in FIG. 3, association mapping 304 may exist between table 1 and table 2 304a, between table 2 and table 3 304b, between table 2 and table 4 304c, and between table 4 and table N 304d. When searching the data or information in table 1 which may be responsive to the original query, using the associated navigation mapping, the related, collaborative or ontological data or information in tables 2, 3, 4, and N can be retrieved or pre-fetched. The related, collaborative or ontological data or information may then be presented or sent to the requester or user in addition to the data or information responsive to the original query.

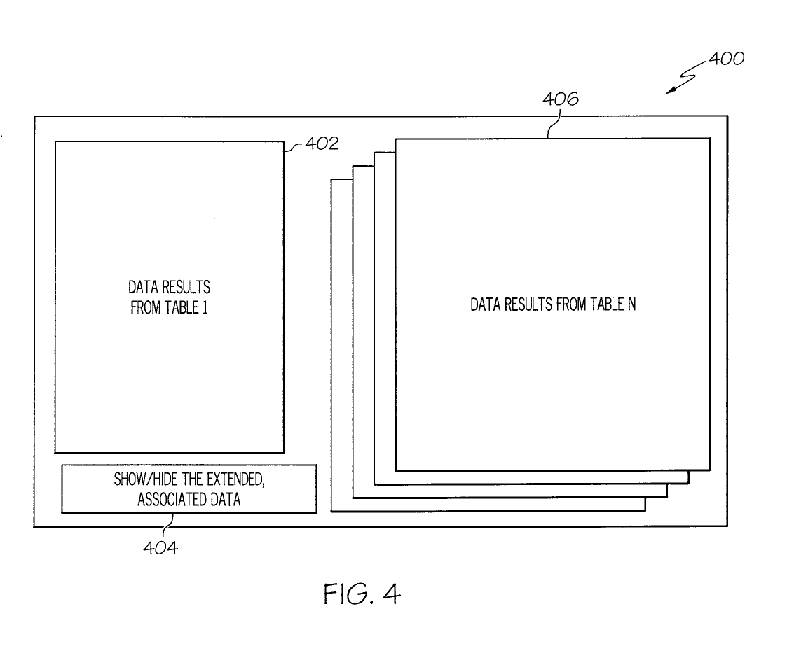

In block 112, an option may be presented or sent to the user to select whether the additional related, collaborative or ontological data or information is also presented to the user. FIG. 4 is an illustration of an exemplary display 400 for presenting information related to the original query and corresponding ontological or collaborative information in accordance with an embodiment of the present invention. The information or data results from table 1 which may be responsive to the original query may be presented in an area 402 or the display 400. A button 404 or other mechanism may be provided for the user to select whether to show or hide the extended, associated data or information or ontological data or information related to the information responsive to the original query. The button 404 may be a toggle button to selectively either show or hide the extended, associated ontological data or information upon successive operations of the button 404. The data or information from other tables, such as table N as illustrated in FIG. 4 may be presented in an area 406 of the display. The area 406 may be a tabbed area to permit selection of the data or information contained in each of the other tables as illustrated in FIGS. 3 and 4.

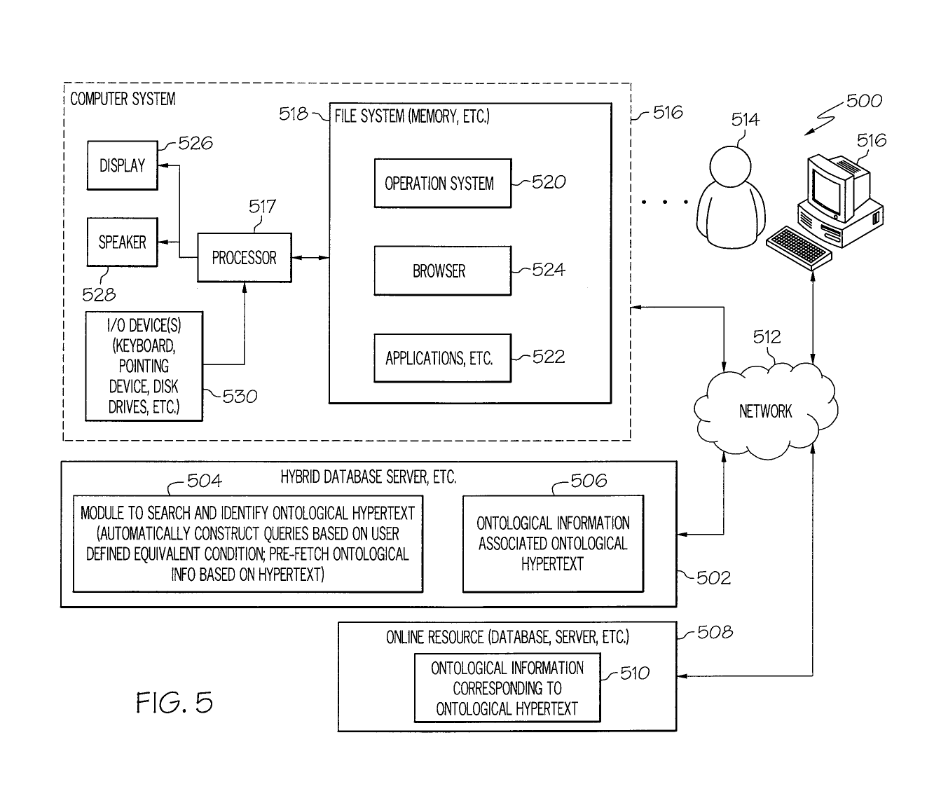

FIG. 5 is a block schematic diagram of an example of a system 500 for identifying ontological hypertext and pre-fetching and presenting the target information in accordance with another embodiment of the present invention. The method 100 of FIG. 1 may also be embodied in or performed by the system 500. The system may include a database server 502. Similar to that previously described, the database server 502 may be hybrid database server or similar database server capable of or adapted to combine relational database functionality with XML support or support of a similar mark-up language or the like. The system 500 may include a module 504 stored on the database server and operable on the database server for identifying ontological hypertext and pre-fetching and presenting the target information. The target information may be defined herein as data or information responsive to an original query and the extended, associated ontological data or information results. The module 504 may be stored on a file system of the server 502. Portions of or all of the method 100 may be embodied in or performed by the module 504.

As previously described, related, collaborative or associated ontological data or information 506 may also be stored on the database server 502. The ontological data or information 506 may be stored in different tables and linked or associated with one another via ontological hypertext similar to that described with referenced to FIG. 3.

Also as previously described, a portion or all of the associated ontological data or information 506 may be pre-fetched or retrieved from another online resource 508. The online resource 508 may be another database or server which may store related information or ontological information 510. The related information may be retrieved or pre-fetched via a network 512.

A user 514 may use a computer system 516 to access the server 502 and module 504 for submitting queries and receiving responses to such queries including extended or enhanced, associated ontological data or information similar to that described herein.

The computer system 516 may include a processor 517 to control operation of the computer system 516 and a file system 518 or memory. An operating system 520, applications 522 and other programs may be stored on the file system 518 for running or operating on the processor 517. A web or Internet browser 524 may also be stored on the file system 518 for accessing the database server 502 and sending queries to the database server 502 via the network 512. The network 512 may be the Internet, an intranet or other private or proprietary network.

The computer system 516 may also include a display 526, a speaker system 528, and one or more input devices, output devices or combination input/output devices, collectively I/O devices 530. The I/O devices 530 may include a keyboard, pointing device, such as a mouse, disk drives and any other devices to permit a user, such as user 514, to interface with and control operation of the computer system 516 and to access or receive online content. The display 526 may present the online content received by the computer system 516. The speaker 528 may present any sounds associated with the online content.

Other embodiments of the present invention are not limited to only a server and the system and features described herein may be in one of many forms. Examples may include a client, configurations that support peer-to-peer communications, a wireless solution or other arrangements.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable other of ordinary skill in the art to understand the invention for various embodiments with various modifications as are suited to the particular use contemplated.

What is claimed is:

1. A computer implemented method for identifying ontological hypertext and pre-fetching and presenting the target information, comprising:
receiving an original query by a database server;
searching the database server to locate an ontological mapping record, wherein the ontological mapping record represents an association between information responsive to the original query and related information associated by ontological hypertext; and
presenting information responsive to the original query and the related information.

2. The computer implemented method of claim 1, further comprising searching the database server to identify the ontological hypertext.

3. The computer implemented method of claim 2, further comprising validating any target ontologies and other knowledge entities associated with the related information.

4. The computer implemented method of claim 1, further comprising automatically constructing an associated query based on an equivalent condition defined in the ontological mapping record to identify ontological information corresponding to the related information.

5. The computer implemented method of claim 4, further comprising pre-fetching the ontological information based on the ontological hypertext.

6. The computer implemented method of claim 5, further comprising storing the ontological information on the database server.

7. The computer implemented method of claim 6, further comprising providing an option for presentation of the ontological information and the related information.

8. The computer implemented method of claim 1, further comprising performing the method on a hybrid database server.

9. The computer implemented method of claim 1, further comprising using the ontological mapping record to retrieve the related information in other tables stored on the database server associated with the information responsive to the original query on a first table.

10. A system for identifying ontological hypertext and pre-fetching and presenting the target information, comprising:
a database server;
a module on the database server to search the database server to identify ontological hypertext, wherein the ontological hypertext associates information responsive to an original query received by the database server to ontological information, the ontological information being information related to the information responsive to the original query; and
a module on the database server to send the information responsive to the original query and the ontological information to a requester that sent the original query.

11. The system of claim 10, further comprising a module to automatically construct another query based on a user equivalent condition to identify the ontological information and to generate an ontological mapping record of the ontological information to permit retrieval of the ontological information.

12. The system of claim 11, further comprising a module to search the database server to locate the ontological mapping record for retrieval of the ontological information.

13. The system of 12, further comprising a module to validate any target ontological information and other knowledge entities related to the information responsive to the original query.

14. The system of claim 11, further comprising:
a module to pre-fetch the ontological information based on the ontological hypertext; and
a database to store the ontological information on the database server.

15. The system of claim 14, wherein the database server comprises a plurality of tables, wherein a first table contains information responsive to the original query and the ontological mapping record is used to retrieve the ontological information in other tables from the first table.

16. The system of claim 11, wherein the database server comprises a hybrid database server.

17. A computer program product for identifying ontological hypertext and pre-fetching and presenting the target information, the computer program product comprising:
a computer readable storage medium having computer readable program code embodied therewith, the computer readable program code comprising:
computer readable program code configured to receive an original query by a database server;
computer readable program code configured to search the database server to locate an ontological mapping record, wherein the ontological mapping record represents an association between information responsive to the original query and related information associated by ontological hypertext; and
computer readable program code configured to present information responsive to the original query and the related information.

18. The computer program product of claim 17, further comprising computer readable program code configured to search the database server to identify the ontological hypertext.

19. The computer program product of claim 17, further comprising:
computer readable program code configured to automatically construct another query based on a user defined equivalent condition to identify ontological information corresponding to the related information;
computer readable program code configured to pre-fetch the ontological information based on the ontological hypertext; and
computer readable program code configured to store the ontological information on the database server.

20. The computer program product of claim 17, further comprising computer readable program code configured to use the ontological mapping record to retrieve the related information in other tables stored on the database server associated with the information responsive to the original query on a first table.
